(19) United States
(12) Patent Application Publication
(10) Pub. No.: US 2026/0073890 A1
(43) Pub. Date: Mar. 12, 2026

(54) Non-Transitory Computer-Readable Storage Medium and Signal Output Apparatus

(71) Applicant: YAMAHA CORPORATION, Hamamatsu-shi (JP)

(72) Inventors: Yoshinobu TERAZAKI, Hamamatsu-shi (JP); Kazuhiro TANI, Hamamatsu-shi (JP); Kentaro EMURA, Hamamatsu-shi (JP); Ryohei TAKEUCHI, Hamamatsu-shi (JP); Takuma TAKEMOTO, Hamamatsu-shi (JP); Naoyuki ONOZAWA, Hamamatsu-shi (JP); Akie HINOKIO, Hamamatsu-shi (JP)

(21) Appl. No.: 18/882,838

(22) Filed: Sep. 12, 2024

Related U.S. Application Data
(63) Continuation of application No. PCT/JP2022/011339, filed on Mar. 14, 2022.

(51) Int. Cl. G09G 5/00; G10H 1/045

(52) U.S. Cl. CPC G09G 5/006; G10H 1/045; G09G 2370/042

(57) ABSTRACT

A signal output apparatus includes an information obtainer, a signal processor, and a signal outputter. The information obtainer obtains identification information regarding sound processing from a medium. The signal processor subjects a sound signal to the signal processing based on the identification information. The signal outputter outputs the sound signal subjected to the signal processing.

### CROSS-REFERENCE TO RELATED APPLICATIONS

The present application is a continuation application of International Application No. PCT/JP2022/011339, filed Mar. 14, 2022. The contents of this application are incorporated herein by reference in their entirety.

### BACKGROUND

The present disclosure relates to a non-transitory computer-readable storage medium and a signal output apparatus.

An effector processes a sound signal through various signal processing techniques to add a sound effect to the original audio. Conventionally, signal processing has been implemented using software or hardware such as electrical circuits. See, for example, Japanese Translation of PCT International Application Publication No. JP-T-2020-508495. A hardware-based effector includes operation devices designed to adjust multiple parameters corresponding to predefined types of sound effects. These operation devices allow for the adjustment of parameter setting values.

In contrast, software-based effectors can be implemented as a function on devices such as mobile phones, tablets, and personal computers. As a result, various types of sound effects can be supported by modifying the software or adding plugins. Such effectors can display a settings screen on a display and accept various setting changes through operation devices, allowing for the control of many parameters and the addition of diverse sound effects without the need for numerous physical operation devices.

In software-based effectors, the wide range of possible settings can sometimes require complex operations. Additionally, in effectors implemented on mobile devices, it is necessary to use a small touch panel, sometimes resulting in poor usability.

It is an object of the present disclosure to the operability of parameter settings in devices that perform signal processing, such as for sound effects.

### SUMMARY

One aspect is a non-transitory computer-readable storage medium that stores a program. When the program is executed by at least one processor, the program causes the at least one processor to obtain identification information regarding sound processing from a medium via an information obtainer. The program also causes the at least one processor to subject a sound signal to the signal processing based on the identification information. The program also causes the at least one processor to output the sound signal that has been subjected to the signal processing.

Another aspect is a signal output apparatus that includes an information obtainer, a signal processor, and a signal outputter. The information obtainer is configured to obtain identification information regarding sound processing from a medium. The signal processor is configured to subject a sound signal to the signal processing based on the identification information. The signal outputter is configured to output the sound signal subjected to the signal processing.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a schematic illustration of an example application of a signal output apparatus according to an embodiment;

FIG. 2 is a schematic illustration of a hardware configuration of the signal output apparatus according to the embodiment;

FIG. 3 is a schematic illustration of a setting table according to the embodiment;

FIG. 4 is a schematic illustration of a functional configuration of the signal output apparatus according to the embodiment;

FIG. 5 is a schematic illustration of a relationship between a setting screen and effector cards according to the embodiment;

FIG. 6 is a schematic illustration of a relationship between the setting screen according to the embodiment and the effector card;

FIG. 7 is a schematic illustration of a relationship between the setting screen according to the embodiment and the effector card;

FIG. 8 is a schematic illustration of a signal processing method according to the embodiment;

FIG. 9 is a schematic illustration of setting update processing according to the embodiment;

FIG. 10 is a schematic illustration of detailed setting processing according to the embodiment;

FIG. 11 is a schematic illustration of a relationship between a setting screen and effector cards according to an embodiment;

FIG. 12 is a schematic illustration of a relationship between a setting screen and effector cards according to an embodiment;

FIG. 13 is a schematic illustration of a relationship between a setting screen and effector cards according to an embodiment;

FIG. 14 is a schematic illustration of a functional configuration of a signal output apparatus according to an embodiment;

FIG. 15 is a schematic illustration of a setting change screen according to an embodiment;

FIG. 16 is a schematic illustration of an example application of a signal output apparatus according to an embodiment;

FIG. 17 is a schematic illustration of a functional configuration of a signal output apparatus according to an embodiment;

FIG. 18 is a schematic illustration of an example application of a signal output apparatus according to an embodiment;

FIG. 19 is a schematic illustration of a functional configuration of the signal output apparatus according to the embodiment;

FIG. 20 is a schematic illustration of an example application of a signal output apparatus according to an embodiment;

FIG. 21 is a schematic illustration of a time management table according to the embodiment; and

FIG. 22 is a schematic illustration of a time management method according to the embodiment.

### DESCRIPTION OF THE EMBODIMENTS

The present specification is applicable to a non-transitory computer-readable storage medium and a signal output apparatus.

Embodiments of the present disclosure will be described in detail with reference to the accompanying drawings. The following embodiments are provided as examples only and should not be construed as limiting the scope of this disclosure. In the accompanying drawings referenced in the embodiments, similar reference numerals, characters, or symbols may be used to indicate corresponding or identical elements. For example, to distinguish like elements, “A” may be appended to a reference numeral and “B” may be appended to the same reference numeral. The drawings may be schematic, and some components may be omitted for clarity in the explanation.

### Overview

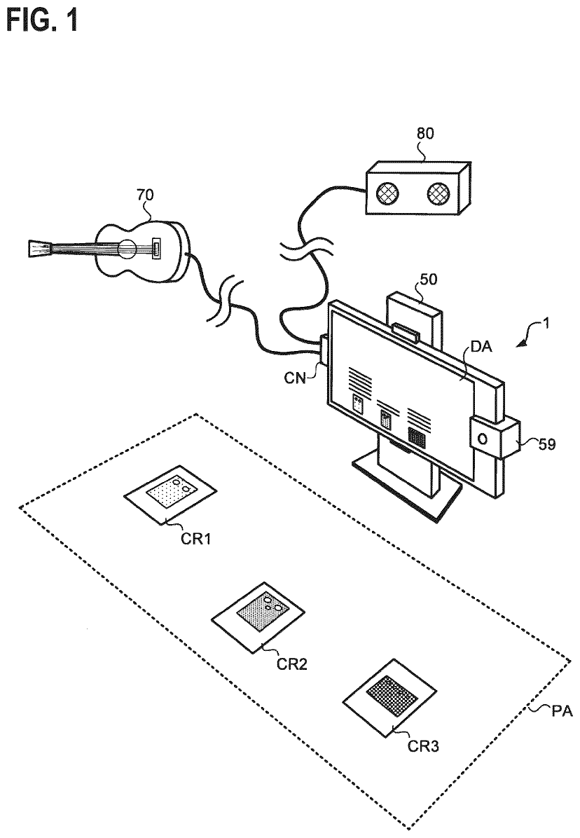

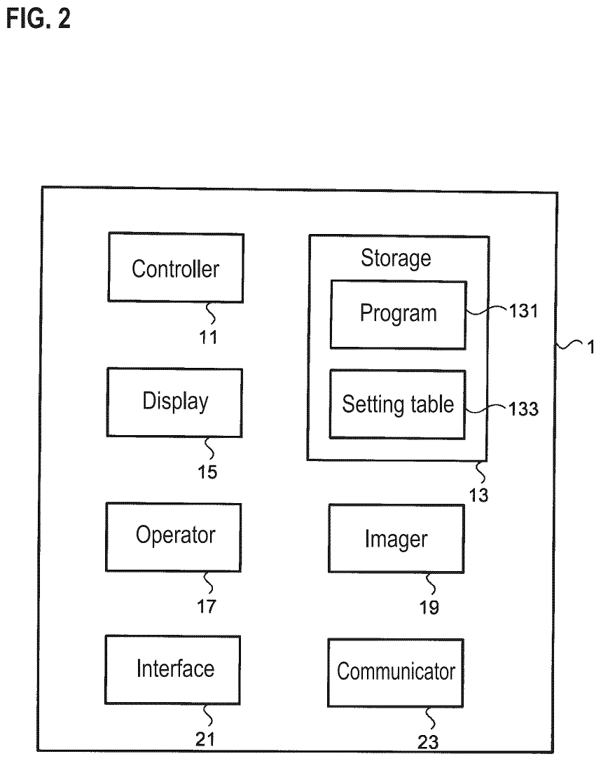

FIG. 1 is a schematic illustration of an example application of a signal output apparatus 1 according to an embodiment. In this embodiment, the signal output apparatus 1 is a smartphone. The signal output apparatus 1 may be a tablet personal computer, a laptop personal computer, or a desktop personal computer. The signal output apparatus 1 includes a display 15, an imager 19, and an interface 21 (see FIG. 2). The display 15 displays images in a display area DA. The imager 19 captures an image of a predetermined imaging range. The interface 21 is connectable to external devices.

As illustrated in FIG. 1, the signal output apparatus 1 is held by a holder 50. In this example, an optical unit 59 is mounted on the signal output apparatus 1 to widen the imaging range imaged by the imager 19. As illustrated in FIG. 1, an imaging range PA indicates a widened imaging range realized by the optical unit 59. Via a connector CN, the interface 21 is connected with a musical instrument 70, such as an electric guitar, and a speaker device 80. The musical instrument 70 has a function of outputting a sound signal when the musical instrument 70 is played by a user. The musical instrument 70 may be a device that outputs a sound signal from a microphone. The speaker device 80 is a sound emission device that converts a supplied sound signal into an air vibration and outputs the air vibration into the air.

When the user plays the musical instrument 70, the sound signal output from the musical instrument 70 is output from the speaker device 80 via the signal output apparatus 1. In this respect, the signal output apparatus 1 subjects the sound signal to signal processing based on three effector cards CR1, CR2, and CR3, which are arranged in the imaging range PA in FIG. 1. Each of the effector cards CR1, CR2, and CR3 is a medium example. In this example, the sound processing corresponds to adding a sound effect. In this example, each card is made of paper and depicts a picture resembling an effector. Each card may be made of plastic, metal, or wood.

The signal output apparatus 1 determines sound effects based on the pictures included in the effector cards CR1, CR2, and CR3, and displays images connected to the sound effects in the display area DA. A screen displayed in the display area DA as a result of this procedure may occasionally be referred to as setting screen. The user can instruct the signal output apparatus 1 to change the sound effect settings by moving the effector cards CR1, CR2, and CR3, or by performing operations such as finger movements near the cards. At this time, the content of the setting screen changes according to the sound effect settings. A configuration and an operation of the signal output apparatus 1 will be described in detail below.

### Configuration of Signal Output Apparatus

FIG. 2 is a schematic illustration of a hardware configuration of the signal output apparatus 1 according to the embodiment. The signal output apparatus 1 includes a controller 11, a storage 13, the display 15, an operator 17, the imager 19, the interface 21, and a communicator 23. The signal output apparatus 1 may include any other elements such as a microphone, a speaker, a position detection sensor, and an acceleration sensor.

The controller 11 includes a processor (such as a CPU or DSP), a RAM, and a ROM. The controller 11, at its CPU, executes a program stored in the storage 13 to perform processing based on commands written in the program. This program includes a program 131. The program 131 is a program for implementing a signal processing function, as described later. The signal processing function is a function for performing a signal processing method. The elements of the signal output apparatus 1 output signals to be used by various functions implemented by the signal output apparatus 1.

The storage 13 includes a storage device such as a nonvolatile memory. The storage 13 stores the program 131 and a setting table 133. The program 131 may be a computer-executable program. Specifically, the program 131 may be provided to the signal output apparatus 1 in the form of a computer readable storage medium such as a magnetic storage medium, an optical storage medium, a magneto-optical storage medium, and a semiconductor memory. In this case, the signal output apparatus 1 may include a device to read the storage medium. The program 131 may be downloaded in the signal output apparatus 1 via the communicator 23. The setting table 133 may be developed in the storage 13 upon execution of the program 131. The storage 13 is a storage medium example.

The display 15 includes a display device such as a liquid crystal display. The display 15 displays various screens in the display area DA under the control of the controller 11. The displayed screens include the above-described setting screen.

The operator 17 in this example includes an operation device such as a touch sensor provided on the surface of the display area DA. The operator 17 receives the user's operation and outputs a signal based on the operation to the controller 11. A combination of the operator 17 and the display 15 constitutes a touch panel. The user contacts the operator 17 using a stylus pen or the user's finger to input into the signal output apparatus 1 a command or information based on the user's operation. The operator 17 may include an operation device such as a switch provided at an enclosure of the signal output apparatus 1.

The imager 19 includes an imaging device such as an image sensor. The imager 19 images the imaging range PA under the control of the controller 11, and generates data indicating an image corresponding to the imaging range PA. The term “image” is intended to encompass a still image, a sequence of still images, multiple still images spaced throughout time, or images in the form of a video.

The interface 21 includes a terminal to connect an external device to the signal output apparatus 1. Examples of the external device include the musical instrument 70, such as an electric guitar, and the speaker device 80. In this example, the signal output apparatus 1 transmits a sound signal to the external device via the interface 21, and receives a sound signal from the external device via the interface 21. The interface 21 may include a terminal to send and receive MIDI data. It is possible to use the connector CN to support various forms of terminals between the interface 21 and the external device so that various kinds of signals can be communicated between the interface 21 and the external device.

The communicator 23 includes a communication module to, under the control of the controller 11, communicate various kinds of data to and from another device connected to the communicator 23 via a network. The communicator 23 may include a communication module to perform infrared communication or near-field wireless communication. The above concludes the description of the hardware configuration of the signal output apparatus 1.

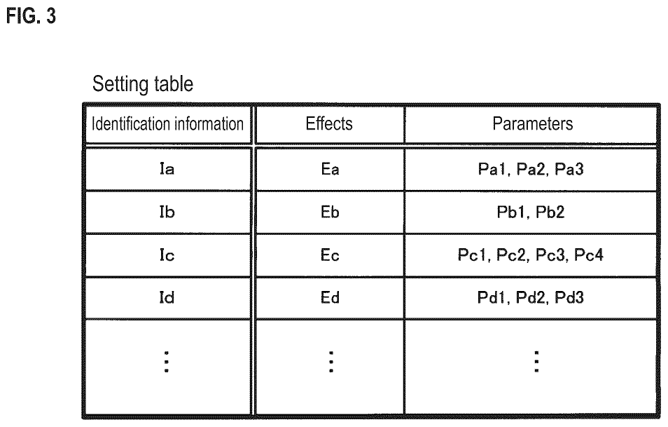

FIG. 3 is a schematic illustration of the setting table 133 according to the embodiment. The setting table 133 specifies Identification information, Effect, and Parameter. The Identification information section indicates information regarding sound processing and included in each effector card illustrated in FIG. 1. In this example, the identification information corresponds to feature information Ia, Ib, Ic, and so forth. The feature information is extractable from the picture depicted in the each effector card, as described later.

The Effect section indicates sound effect type (Ea, Eb, Ec, and so forth). Examples of the sound effect type include reverberation (reverb), chorus, and distortion. The Parameter section indicates which of the parameters used in sound effects have adjustable setting values. The setting table 133 indicates that for Effect Ea, the setting values of three kinds of parameters Pa1, Pa2, and Pa3 are adjustable. In a case that the sound effect type is chorus, parameter type examples are output level (LEVEL), speed (SPEED), and depth (DEPTH).

Thus, the identification information can be regarded as including information for identifying the sound effect type and parameter type.

In this example, for any sound effect type, there exists a parameter at least corresponding to the output level. In the following description, the output level may occasionally be referred to simply as level.

### Configuration of Signal Processing Function

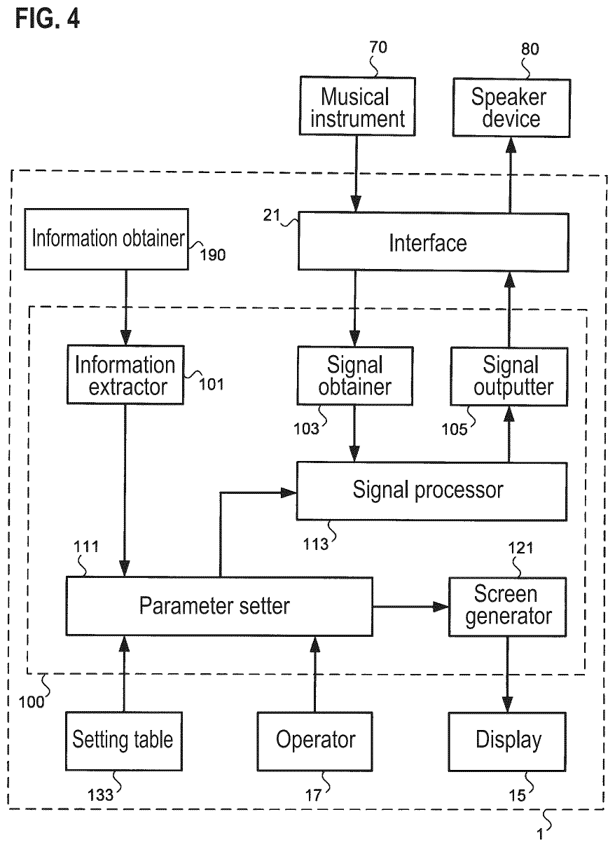

With reference to FIG. 4, a signal processing function 100 will be described. The signal processing function 100 is implemented by the controller 11 executing the program 131.

FIG. 4 is a schematic illustration of a functional configuration of the signal output apparatus according to the embodiment. The signal processing function 100 includes an information extractor 101, a signal obtainer 103, a signal outputter 105, a parameter setter 111, a signal processor 113, and a screen generator 121. The signal processing function 100 may not necessarily be entirely implemented by executing a program; the signal processing function 100 may be at least partially implemented by hardware.

The information extractor 101 extracts feature information from information obtained by an information obtainer 190. The feature information corresponds to the identification information specified in the setting table 133. In this example, the information obtainer 190 includes the imager 19. Therefore, the information obtained by the information obtainer 190 corresponds to an image captured within the imaging range PA (this image will be hereinafter occasionally referred to as captured image). The information obtainer 190 can be regarded as including a configuration (in this example, the imager 19) for obtaining identification information from the effector card in which the identification information is recorded. In a case that the information extractor 101 has extracted predetermined feature information from the captured image as a result of analyzing the captured image, the information extractor 101 also identifies the position in the imaging range PA where the feature information was extracted (this position will be hereinafter occasionally referred to as extraction position).

The feature information is information for identifying the effector card. Specifically, the feature information is information indicating a feature of the picture included in the effector card. More specifically, the feature information corresponds to information such as the picture's outline, color, and pattern. The pattern may be a two-dimensional code. The feature information based on color may be treated as identical within a predetermined range of differences, considering color fading over time. Alternatively, the feature information based on color before fading may be treated as different from the feature information based on color after fading. The feature information may be information obtained by imaging the effector card. In this respect, the feature information may be information based on the outer shape of the effector card.

In a case that the information extractor 101 has extracted a plurality of pieces of feature information, the information extractor 101 identifies a plurality of extraction positions respectively corresponding to the plurality of pieces of feature information. For example, in a case that the three effector cards CR1, CR2, and CR3 exist in the imaging range PA, as illustrated in FIG. 1, the information extractor 101 extracts three pieces of feature information. The information extractor 101 relates the identified extraction positions to the respective three pieces of feature information, and outputs the resulting pieces of information to the parameter setter 111. The information extractor 101 also analyzes the captured image to detect human fingers. Then, the information extractor 101 outputs information regarding the positions of the human fingers (for example, the positions of the fingertips) to the parameter setter 111. The position of each human finger detected in this manner may occasionally be referred to as finger detection position.

The signal obtainer 103 obtains a sound signal from the musical instrument 70 connected to the interface 21, and supplies the obtained sound signal to the signal processor 113.

The signal processor 113 subjects the sound signal supplied from the signal obtainer 103 to signal processing. Specifically, the signal processor 113 adds a sound effect based on a parameter setting to the sound signal. Then, the signal processor 113 supplies the processed sound signal to the signal outputter 105. The type and setting value of the parameter used in the signal processing performed by the signal processor 113 are set by the parameter setter 111 based on the identification information.

The signal outputter 105 outputs the sound signal supplied from the signal processor 113 to the speaker device 80 connected to the interface 21.

Based on the feature information and the extraction position supplied from the information extractor 101, the parameter setter 111 sets parameters to be used in the signal processing by the signal processor 113. At the time of initial setting, the parameter setter 111 refers to the setting table 133 to identify the effect types and parameter types corresponding to the feature information, and sets the parameters in the signal processor 113. The value (initial value) first set to each parameter may be specified in the setting table, may be included in the feature information, or may be determined in advance.

Then, upon a change in the extraction position, the parameter setter 111 adjusts the setting value of each parameter based on the change in the extraction position. That is, a change in the position of the effector card is measured, and the parameter setter 111 adjusts the setting value of each parameter based on the change in the position of the effector card.

The parameter setter 111 further adjusts the setting value of each parameter based on a relationship between the finger detection position and the extraction position supplied from the information extractor 101. That is, the user's operation state with respect to the effector card is measured, and the parameter setter 111 adjusts the setting value of each parameter based on the operation state. The parameter setter 111 may adjust the setting value of each parameter based on the user's instruction input via the operator 17. Details of the processing performed by the parameter setter 111 will be described later.

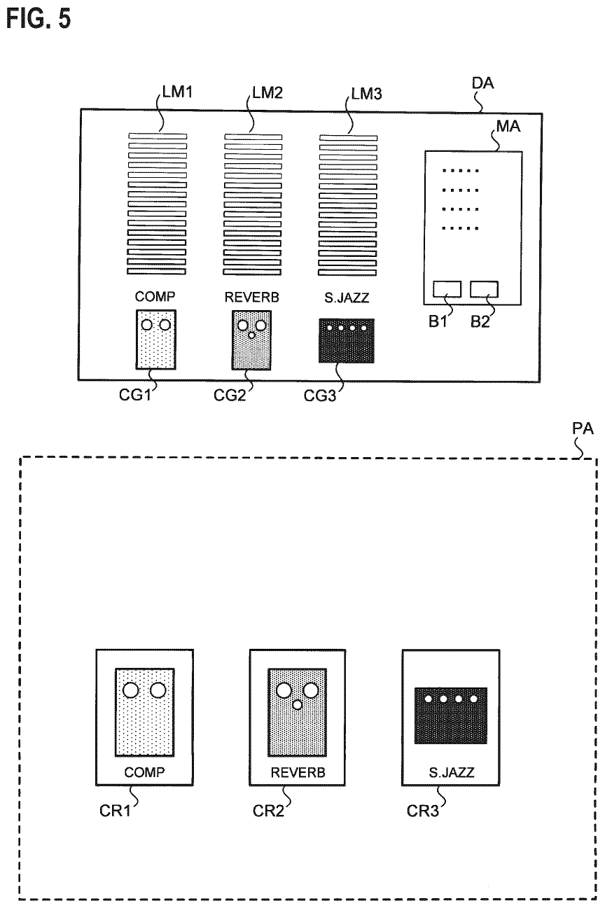

In this example, the parameter setter 111 outputs an instruction to the screen generator 121 to display setting screens (for example, FIGS. 5 to 7) in the display area DA. Each setting screen includes an image that is based on the content of the signal processing. For example, each setting screen includes an image showing the sound effect type. In this example, each setting screen further includes an image showing at least one parameter setting value.

Based on the instruction of the parameter setter 111, the screen generator 121 generates a setting screen to be displayed in the display area DA. The image displayed in the display area DA may include other than the setting screen. The above concludes the description of the signal processing function 100.

### Display Example of Setting Screen

With reference to FIGS. 5 to 7, description will be made with regard to: a relationship of the setting screen displayed in the display area DA with the effector cards CR1, CR2, and CR3 in the imaging range PA; and a transition example of the setting screen. The transition of the setting screen described in this example is implemented by processing performed by the signal processing function 100.

FIGS. 5 to 7 are each a schematic illustration of a relationship between a setting screen and effector cards according to the embodiment. The display area DA and the imaging range PA in FIGS. 5 to 7 respectively correspond to the display area DA and the imaging range PA illustrated in FIG. 1. In the imaging range PA, the effector cards CR1, CR2, and CR3 are arranged. As described above, the effector cards CR1, CR2, and CR3 each include a picture resembling sound effect type. For example, the effector card CR1 includes a picture resembling an effector device that adds sound effect “COMP”. The sound effect “COMP” corresponds to, for example, a sound effect of a compressor.

The setting screen displayed in the display area DA includes effector images CG1, CG2, and CG3, level meters LM1, LM2, and LM3, and a menu area MA. The effector images CG1, CG2, and CG3 are identification image examples for identifying the sound effect types respectively corresponding to the effector cards CR1, CR2, and CR3. In this example, each identification image is an image corresponding to a picture depicted in the corresponding effector card, and includes an image resembling an effector that adds a sound effect. In the following description, the sound effect types corresponding to the effector images CG1, CG2, and CG3 may occasionally be referred to as setting effectors SE1, SE2, and SE3, respectively.

The level meter LM1 is displayed at a position corresponding to the effector image CG1 (in this example, above the effector image CG1). The level meter LM2 is displayed at a position corresponding to the effector image CG2 (in this example, above the effector image CG2). The level meter LM3 is displayed at a position corresponding to the effector image CG3 (in this example, above the effector image CG3). The level meter LM1 is an image corresponding to the value set as the level of the setting effector SE1 (this value will hereinafter occasionally be referred to as level setting value). The level meter LM2 is an image corresponding to the value set as the level of the setting effector SE2. The level meter LM3 is an image corresponding to the value set as the level of the setting effector SE3.

The menu area MA includes operation button images for inputting various operations into the signal output apparatus 1. In this example, the user operates operation button images B1 and B2 to input instructions into the signal output apparatus 1. The input instructions include an instruction for determining initial state and an instruction for ending the signal processing. The menu area MA may include information regarding the setting effector SE1, information regarding the setting effector SE2, and information regarding the setting effector SE3. Such information may include, for example: setting values of a plurality of parameters used in the setting effectors SE1, SE2, and SE3; and a description of the sound effect added by the effector.

In the display area DA before the state illustrated in FIG. 5, only the menu area MA is displayed; that is, the effector images CG1, CG2, and CG3 and the level meters LM1, LM2, and LM3 are not displayed in the display area DA. The user inputs an instruction for arranging the effector cards CR1, CR2, and CR3 in the imaging range PA and for determining initial state. Upon input of this instruction, the effector images CG1, CG2, and CG3 and the level meters LM1, LM2, and LM3 are displayed in the display area DA, as illustrated in FIG. 5. The level meters LM1, LM2, and LM3 each include a plurality of scale areas, and illuminate the number of scale areas corresponding to the level setting value. The order in which the effector images CG1, CG2, and CG3 are displayed corresponds to the order in which the effector cards CR1, CR2, and CR3 are arranged in the imaging range PA.

In the example illustrated in FIG. 5, all the scale areas of the level meters LM1, LM2, and LM3 are unlit. This state indicates that the setting effectors SE1, SE2, and SE3 are turned off. The setting effectors SE1, SE2, and SE3 are turned on and off by the user making a predetermined first operation on the effector cards CR1, CR2, and CR3. In this example, the first operation is a single tap with a finger. For example, when the user taps the effector card CR1 once with a finger, the setting effector SE1 is turned on (activated). In the ON state of the setting effector SE1, the level meter LM1 illuminates the number of scale areas corresponding to the level setting value. At an initial stage, the level meter LM1 illuminates the number of scale areas corresponding to the initial setting value (for example, one scale area).

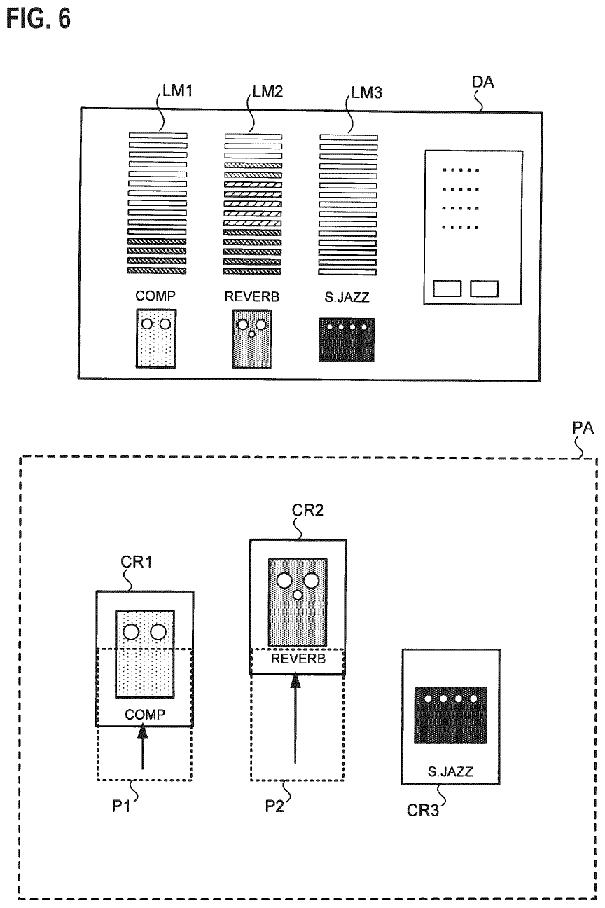

As illustrated in FIG. 6, when the effector card CR1 is moved upward from an initial position P1 of the effector card CR1, the level setting value of the setting effector SE1 increases in response to this change in the position. When the effector card CR2 is moved upward from an initial position P2 of the effector card CR2, the level setting value of the setting effector SE2 increases in response to this change in the position. In the ON state of the setting effectors SE1 and SE2, the level meters LM1 and LM2 illuminate the number of scale areas corresponding to the respective level setting values. In the example illustrated in FIG. 6, the effector card CR2 has a greater upward displacement than the effector card CR1. Therefore, the setting effector SE2 is controlled to have a higher level setting value than the setting effector SE1.

In this respect, when the setting effector SE1 is turned off by tapping the effector card CR1 once, all scale regions on level meter LM1 to extinguish. However, the level setting value at the time before the tapping is retained. Therefore, when the effector card CR1 is tapped once again, turning the setting effector SE1 on, the scale areas of the level meter LM1 illuminate as illustrated in FIG. 6.

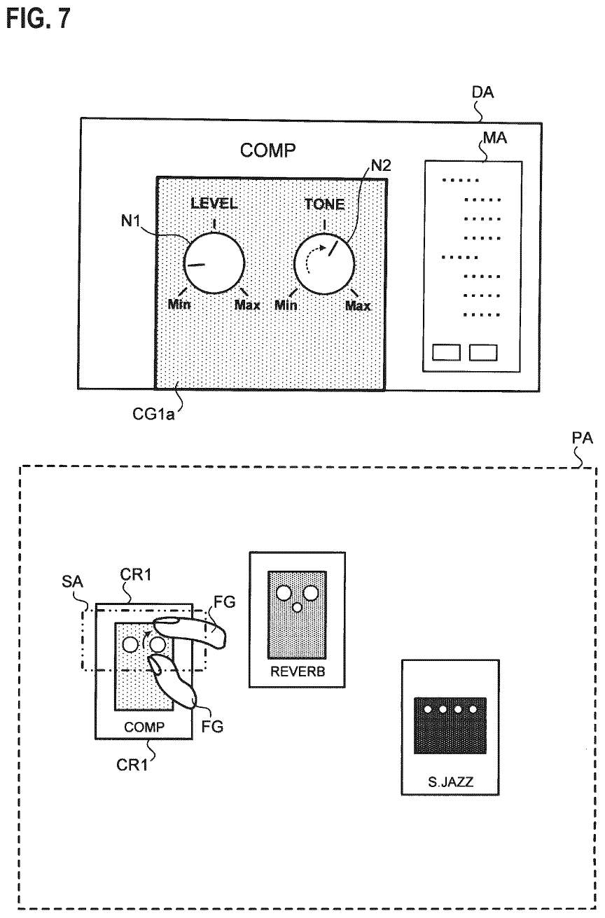

To change the setting values of parameters other than those for the levels of the setting effectors SE1, SE2, and SE3, the user makes a predetermined second operation on the effector cards CR1, CR2, and CR3. In this example, the second operation is a double tap with a finger. When the user taps the effector card CR1 twice with a finger, an enlarged effector image CG1a is displayed in the display area DA as illustrated in FIG. 7. The enlarged effector image CG1a is an image for adjusting a parameter other than the level of the setting effector SE1, for example, the setting value of parameter “TONE”. In this respect, the menu area MA may be adjusted to include a detailed description related to the setting effector SE1 in the content displayed in the menu area MA.

The enlarged effector image CG1a includes a knob image N1 and a knob image N2. The knob image N1 indicates level setting value. The knob image N2 indicates a setting value corresponding to the parameter “TONE” (this setting value will be hereinafter occasionally referred to as tone setting value). The knob image N1 is displayed to indicate the current level setting value.

In the imaging range PA, an area SA at least partially overlaps the effector card CR1. In the area SA, when the user pinches the knob with fingers FG and turn the knob, the movement of the fingers FG is measured as the user's operation with respect to the effector card CR1. The fingers FG can be regarded as instruction objects for the knobs included in the effector card CR. Based on the user's operation state, the setting value of the parameter is adjusted. In this example, the tone setting value is adjusted based on the degree of rotation of the knob. The area SA may be set based on the outer edge of the effector card CR1 or the picture depicted in the effector card CR1. In this respect, an image of a finger, either a simulated image or an image extracted from the captured image, may be superimposed onto the enlarged effector image CG1a in the display area DA at a position corresponding to the detected finger position. This superimposed image serves as an instruction image for operating the knob.

Upon adjustment of the tone setting value, the knob image N2 turns to the position corresponding to the adjusted tone setting value. As illustrated in FIG. 7, when the fingers FG move to turn rightward, the knob image N2 in the enlarged effector image CG1a turns along with the fingers FG. While in FIG. 7 the fingers FG is depicted as turning the knob in the effector card CR1, the knob actually does not turn, since the knob is part of the picture depicted in the effector card CR1.

With the enlarged effector image CG1a displayed in the display area DA, when the user taps the effector card CR1 twice with a finger, the setting screen returns to the image illustrated in FIG. 6. When the user plays the musical instrument 70, the signal output apparatus 1 receives a sound signal from the musical instrument 70 and adds sound effects to the sound signal based on the setting values of the parameters. Then, the signal output apparatus 1 outputs the resulting sound signal to the speaker device 80.

The order in which the sound effects are added to the sound signal is determined based on the positional relationship between the plurality of effector cards. For example, this order is specified by the order in which the effector cards are arranged in a predetermined direction in the imaging range PA. In this example, the order in which the sound effects are added is specified as the order in which the setting effector corresponding to the left effector card is added first of all. Specifically, the sound effect corresponding to the setting effector SE1 is first added to the sound signal. Next, the sound effect corresponding to the setting effector SE2 is added to the sound signal. Lastly, the sound effect corresponding to the setting effector SE3 is added to the sound signal. In the example illustrated in FIG. 6, since the setting effector SE3 is turned off, the sound effect corresponding to the setting effector SE3 is actually not added to the sound signal. The above concludes the description of a display example (screen transition processing) of the setting screen.

### Signal Processing Method

Along with the above-described screen transition processing, the signal processing function 100 performs a signal processing method. This signal processing method will be described below. The signal processing method described here starts upon execution of the program 131.

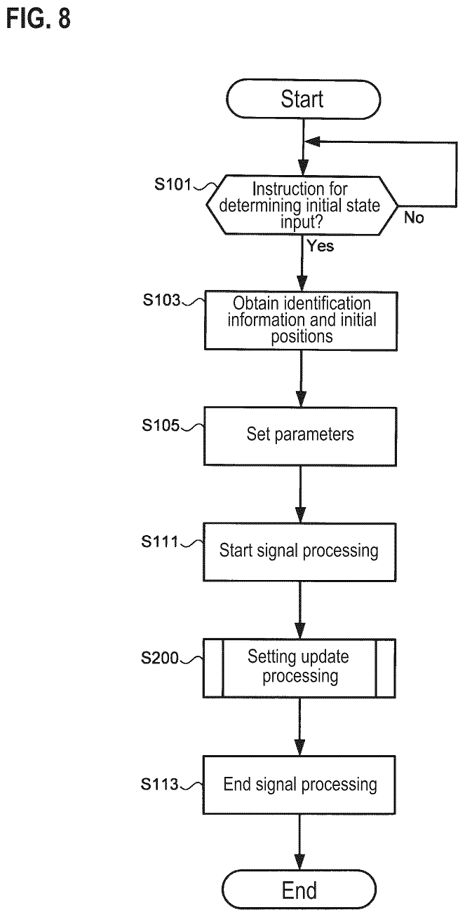

FIG. 8 is a schematic illustration of the signal processing method according to the embodiment. First, the controller 11 waits until the user inputs an instruction for determining initial state (No at step S101). Upon input of the instruction for determining initial state (Yes at step S101), the controller 11 obtains identification information and initial positions from a captured image (step S103).

Specifically, the controller 11 analyzes the captured image obtained by the imager 19 to extract, from the captured image, feature information specified in the setting table 133. In this manner, the controller 11 obtains the identification information. As described above, the feature information is included in each effector card. Thus, by obtaining the identification information, the controller 11 is able to recognize the existence of an effector card in the imaging range PA. Further, by referring to the setting table 133, the controller 11 is able to identify the sound effect types corresponding to the identification information. With reference to the examples illustrated in FIGS. 5 to 7, the sound effect types corresponding to the identification information are identified as types corresponding to the setting effectors SE1, SE2, and SE3. Further, the controller 11 identifies, from the captured image, extraction positions corresponding to the feature information, and obtains the extraction positions as initial positions.

Next, the controller 11 refers to the setting table 133 to set parameters used in the signal processing of adding the identified sound effects to the sound signal (step S105). Then, the controller 11 starts this signal processing on the sound signal that has been input (step S111). That is, the signal output apparatus 1 adds the sound effects to the input sound signal and outputs the resulting sound signal until the signal processing ends. The parameter setting values here are predetermined initial values.

The controller 11 performs setting update processing (step S200). Upon ending of the setting update processing, the controller 11 ends the signal processing on the input sound signal (step S113), ending the signal processing method illustrated in FIG. 8. Next, the setting update processing (step S200) will be described.

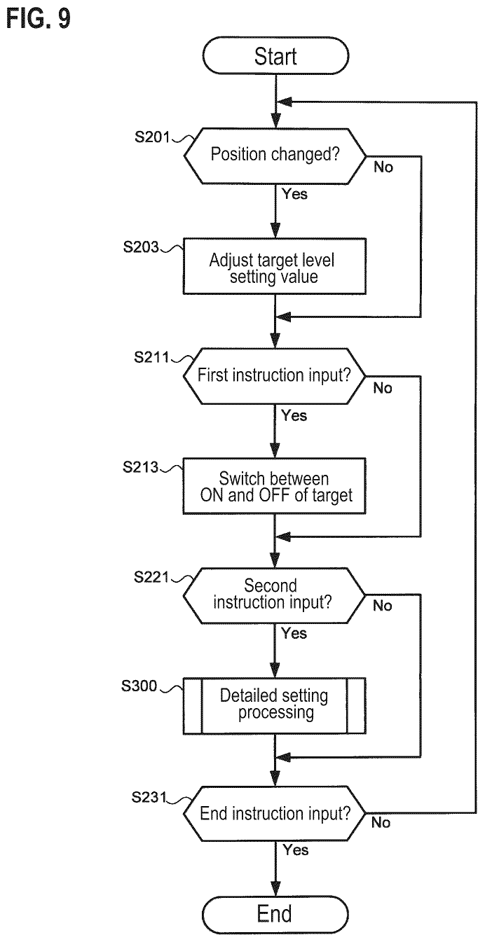

FIG. 9 is a schematic illustration of the setting update processing according to the embodiment. Concurrently with the setting update processing, the controller 11 performs processing of identifying the extraction positions (that is, processing of identifying the positions of the effector cards) and processing of detecting the user's fingers. In the setting update processing, the controller 11 waits until an extraction position is changed, until a first instruction is input, until a second instruction is input, or until an instruction for ending the signal processing is input (No at step S201, No at step S211, No at step S221, and No at step S231). In the following description, this state will be referred to as instruction waiting state. The first instruction corresponds to the above-described first operation (a single tap on the effector card with a finger). The second instruction corresponds to the above-described second operation (a double tap on the effector card with a finger). The first operation and the second operation are detected based on the finger detection position(s).

Upon input of the instruction for ending the signal processing in the instruction waiting state (Yes at step S231), the controller 11 ends the setting update processing.

The controller 11 refers to a measurement result obtained by measuring a change in the position of an effector card. From the measurement result, the controller 11 detects that an extraction position has changed in the instruction waiting state (Yes at step S201). Then, based on the extraction position, the controller 11 adjusts the level setting value at a target corresponding to the extraction position (step S203). As used herein, the target corresponding to the extraction position is intended to mean the setting effector identified from the feature information identified from the extraction position. For example, when the effector card CR1 is moved upward from the initial position P1 as illustrated in FIG. 6, the controller 11 detects that the extraction position corresponding to the setting effector SE1 has move upward. Then, the controller 11 adjusts the level setting value based on the distance between the initial position and the extraction position. Thus, the level setting value is adjusted in coordination with the movement of the extraction position. Accordingly, as the effector card CR1 moves upward, the number of illuminated scale areas of the level meter LM1 increases.

The controller 11 refers to a measurement result obtained by measuring the user's operation state. Upon detecting from measurement result that the first instruction has been input in the instruction waiting state (Yes at step S211), the controller 11 switches between ON and OFF of a target for which the input first instruction was intended (step S213). The target for which the input first instruction was intended is the setting effector corresponding to the effector card that has undergone the single tap (first operation). For example, in a case that a single tap is applied to the effector card CR1, the target for which the input first instruction was intended corresponds to the setting effector SE1.

The controller 11 refers to a measurement result obtained by measuring the user's operation state. Upon detecting from the measurement result that the second instruction has been input in the instruction waiting state (Yes at step S221), the controller 11 performs detailed setting processing (step S300).

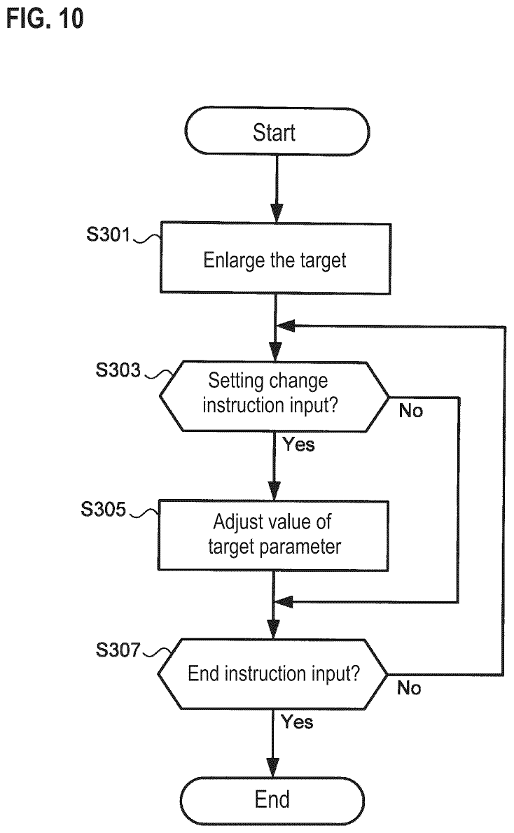

FIG. 10 is a schematic illustration of the detailed setting processing according to the embodiment. The controller 11 displays, in the display area DA, an enlarged effector image of a target for which the input second instruction was intended (step S301). The target for which the input second instruction was intended is the setting effector corresponding to the effector card that has undergone the double tap (second operation). For example, in a case that a double tap is applied to the effector card CR1, the target for which the input second instruction was intended corresponds to the setting effector SE1. As a result, the enlarged effector image CG1a illustrated in FIG. 7 is displayed in the display area DA.

The controller 11 waits until input of a setting change instruction or a detailed setting end instruction (No at step S303, No at step S307).

The controller 11 refers to a measurement result obtained by measuring the user's operation state. Upon detecting from the measurement result that the setting change instruction has been input (Yes at step S303), the controller 11 adjusts the value of a target parameter (step S305). The setting change instruction is input into the signal output apparatus 1 by moving fingers in a manner similar to turning the knob in a predetermined region superimposed over the effector card to which the second instruction has been made (the predetermined region is the area SA in the example illustrated in FIG. 7). Upon adjustment of the parameter value, as exemplified in FIG. 7, the knob in the enlarged effect image in the display area DA turns or undergoes similar changes.

The target parameter is at least one parameter adjustable in the setting effector displayed in the enlarged effect image. For the parameter “LEVEL”, its setting value is adjustable by moving the effector card. Therefore, the target parameter may be a parameter other than “LEVEL”.

There may be a case that the detailed setting processing is performed on a setting effector that supports the adjustment of a plurality of parameters. In this case, the following processing is exemplified. The controller 11 may change the type of the target parameter upon detecting a predetermined operation on the effector card, such as tapping with two fingers. The controller 11 may determine the type of the target parameter based on a positional relationship between the position of a picture depicted in the effector card and the position of the finger movement. For example, in a case that a plurality of knobs are depicted in the effector card, the parameter corresponding to the knob closest to the fingertip may be determined as the target parameter.

Upon input of a detailed setting end instruction (Yes at step S307), the controller 11 ends the detailed setting processing returns to the instruction waiting state described above with reference to FIG. 9. The detailed setting end instruction may be input by making an operation on the operation button image displayed in the menu area MA, or may be input by making a predetermined operation (for example, double tapping operation) on the target effector card.

By using the aforementioned signal processing method, the operations described in FIGS. 5 to 7 can be performed. Specifically, by arranging the effector cards in the imaging range PA, the user is able to set sound effects to be added to the sound signal. Further, by moving an effector card or making an operation on an effector card, the user is able to adjust the value of a parameter related to a sound effect. Thus, the user is able to make settings associated with sound effects using media such as cards, with minimal operation on the operator 17 of the signal output apparatus 1.

In a case that there is only a small user-operable area on the signal output apparatus 1, such as the touch panel, the operability deteriorates during various settings. Additionally, it may not be possible to place the signal output apparatus 1 near the user while playing a musical instrument. The signal output apparatus 1, however, uses a medium such as a card as the target of operation. With this configuration, even in the above-described cases, the signal output apparatus 1 ensures that the operational range is substantially expanded, providing the user with an intuitive and easy-to-understand parameter setting environment during performance.

In the above-described embodiment, each effector card is movable upward or downward in the imaging range PA to adjust the value of a parameter (the level setting value in the above-described embodiment). The direction in which to move each effector card in the imaging range PA will not be limited to upward and downward; various other directions are possible, such as a horizontal direction and a diagonal direction. It is also possible to move each effector card by rotating the each effector card. That is, each effector card may be moved in any manner insofar as the each effector card is displaced from its initial position. In the following embodiment, each parameter value is adjusted by rotating each effector card.

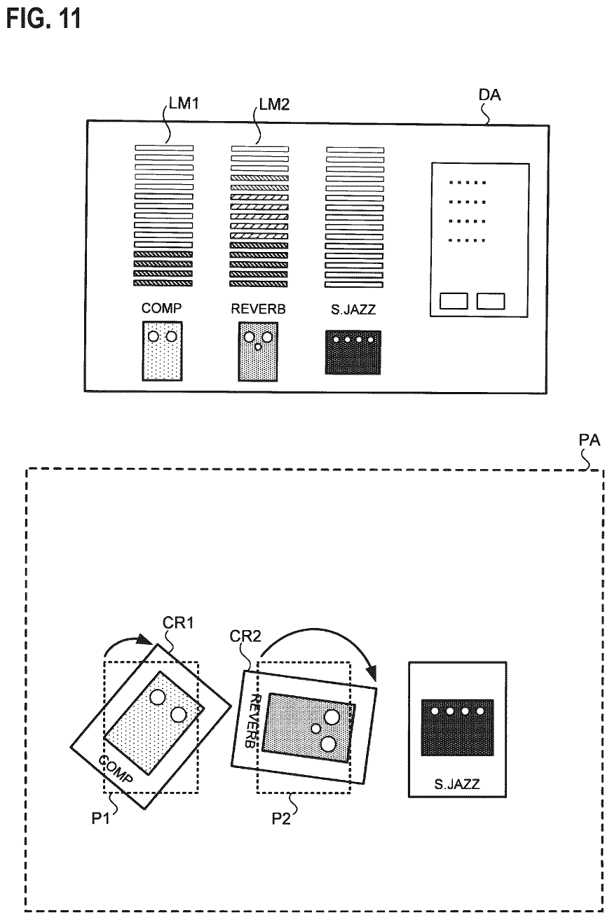

FIG. 11 is a schematic illustration of a relationship between a setting screen and effector cards according to this embodiment. In the embodiment illustrated in FIG. 11, each level setting value is adjusted by rotating each effector card in the imaging range PA. In this case, the information extractor 101 may identify information regarding the rotation of the effector card from a captured image. The information regarding the rotation of the effector card may be information indicating the orientation of the effector card, such as rotation direction and degree of rotation. Thus, a change in the orientation of the effector card is measured, and the setting value of each parameter is adjusted based on the measured change in orientation.

In the example illustrated in FIG. 11, the degree of rotation of the effector card CR2 from its initial position P2 is larger than the degree of rotation of the effector card CR1 from its initial position P1. As a result, the number of illuminated scale areas of the level meter LM2 is larger than the number of illuminated scale areas of the level meter LM1.

It is also possible to use this embodiment in combination with the above-described embodiment. For example, as in the above-described embodiment, the level setting value may be adjusted when the effector card is moved upward or downward. In contrast, the setting value of a parameter different from the parameter “LEVEL” may be adjusted when the effector card is rotated. Similarly, the setting value of still another parameter may be adjusted when the effector card is moved in a horizontal direction.

A function-adding medium may be superimposed over the effector card or attached to the effector card to incorporate an additional type of parameter related to an additional sound effect. Examples of the function-adding medium include a card different from the effector card, a coin, and a sticker. It is possible to use these media to add parameter types related to additional sound effects. In the following embodiment, a function-adding sticker will be described as a function-adding medium example attachable to each effector card.

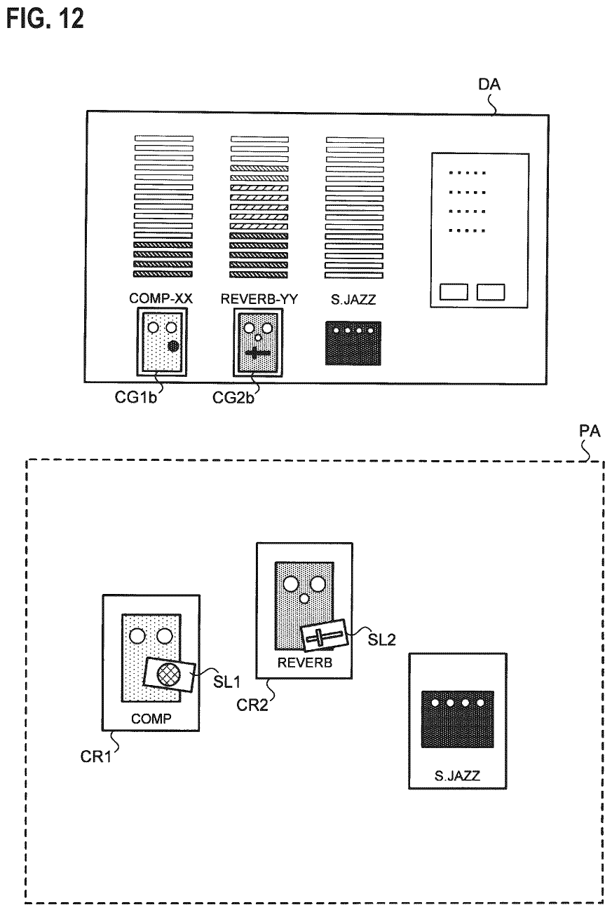

FIG. 12 is a schematic illustration of a relationship between a setting screen and effector cards according to this embodiment. In the example illustrated in FIG. 12, a sticker SL1 is attached to the effector card CR1, and a sticker SL2 is attached to the effector card CR2. The sticker SL1 includes a picture resembling a knob. The sticker SL2 includes a picture resembling a slider. The stickers SL1 and SL2 are examples of the above-described function-adding sticker.

The information extractor 101 extracts feature information regarding the sticker SL1 and the sticker SL2 from the captured image, and also identifies the extraction positions of the sticker SL1 and the sticker SL2 from the captured image. In this manner, the information extractor 101 identifies the positions of the stickers SL1 and SL2 in the imaging range PA. The parameter setter 111 identifies that the sticker SL1 is attached to the effector card CR1 based on the positional relationship between the effector card CR1 and the sticker SL1. The parameter setter 111 also identifies that the sticker SL2 is attached to the effector card CR2 based on the positional relationship between the effector card CR2 and the sticker SL2.

In this example, effector images CG1b and CG2b, instead of the effector images CG1 and CG2 according to the above-described embodiment, are displayed in the display area DA. The effector image CG1b includes an additional image corresponding to the picture of the sticker SL1 (knob in this example). This additional image is incorporated based on the feature information of the sticker SL1. The effector image CG2b includes an additional image corresponding to the picture of the sticker SL2 (slider in this example). This additional image is incorporated based on the feature information of the sticker SL2.

By attaching the sticker SL1 to the effector card CR1, an adjustable parameter type of, for example, “ATTACK” is incorporated in the sound effect “COMP”, in addition to the parameters “LEVEL” and “TONE”. In other words, by attaching the sticker SL1 to the effector card CR1, which corresponds to the sound effect “COMP”, a function to adjust the setting value of the parameter “ATTACK” is added to the setting effector SE1.

The adjustable parameter type varies depending on the target sound effect type. For example, in a case that the sticker SL1 is attached to the effector card CR2, a function to adjust the setting value of a predetermined parameter related to the sound effect “REVERB” is added to the setting effector SE2. In a case that the sticker SL2 is attached to the effector card CR1, the setting value of a parameter “RATIO”, for example, can be adjusted with respect to the sound effect “COMP”. The parameter types that can be added based on the sticker type and the sound effect type may be specified in the setting table 133, for example.

To adjust the setting value of a parameter indicated by a sticker, it is possible to use a method similar to the detailed setting processing described in the above embodiment or a method similar to the rotation-related described in the above embodiment. It is also possible to determine the parameter setting value based on the orientation of the sticker attached to the effector card. In this case, the information extractor 101 may extract the angle formed between a predetermined reference orientation of the effector card and a predetermined reference orientation of the sticker. Then, the information extractor 101 may transmit the extracted angle to the parameter setter 111 as attachment angle. The parameter setter 111 may determine the parameter setting value based on the attachment angle. In this respect, the angle at the time when the sticker was detected for the first time may be regarded as initial angle, and the amount of change in angle from the initial angle may be measured to determine the parameter setting value based on the amount of change.

It is also possible to determine the parameter setting value based on the attachment position of the sticker on the effector card. In this case, the information extractor 101 may extract the position of the sticker on the effector card and transmit the extracted position of the sticker to the parameter setter 111. The parameter setter 111 may determine the parameter setting value based on the extracted position of the sticker. In this respect, the position of the sticker at the time when the sticker was detected for the first time may be regarded as initial position, and the amount of change in the position from the initial position may be measured to determine the parameter setting value based on the amount of change.

While in this example a sticker is used as a function-adding medium, it is also possible to use a card, a coin, or any other medium. Stickers are different from cards and coins in that stickers are adhesive media whereas cards and coins are not adhesive media. An adhesive medium is easier to move while maintaining its positional relationship with the effector card. In contrast, a non-adhesive medium is easier to change its orientation relative to the effector card.

The order in which the sound effects respectively corresponding to the plurality of setting effectors are added may not necessarily be specified by the order in which the effector cards are arranged in a predetermined direction in the imaging range PA. For example, an effect card may be placed on a writable medium, such as paper or a whiteboard, and the order in which the sound effects are arranged may be determined by the information recorded on the medium. In the following embodiment, information described on a medium includes lines.

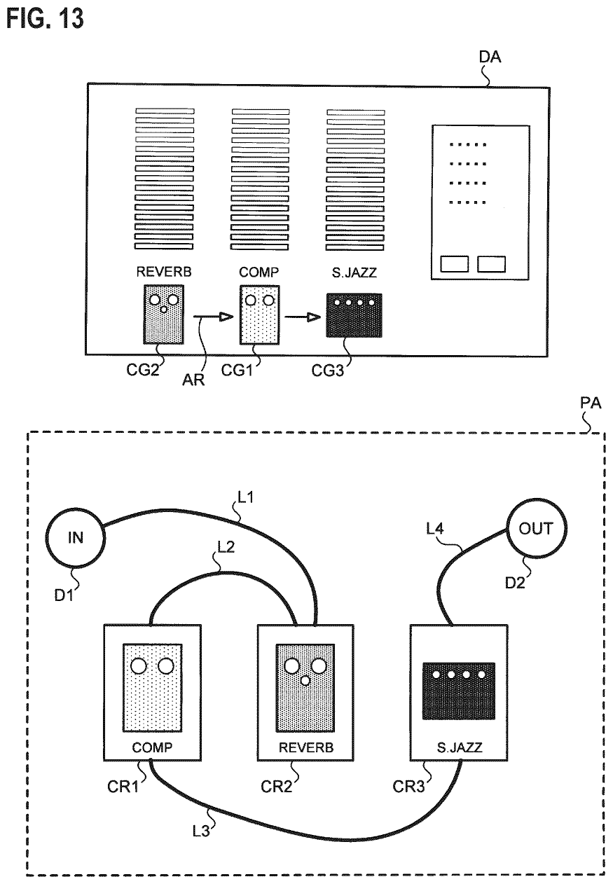

FIG. 13 is a schematic illustration of a relationship between a setting screen and effector cards according to this embodiment. In example illustrated in FIG. 13, the effector cards CR1, CR2, and CR3 are arranged on the whiteboard WB. On the whiteboard WB, information regarding the order in which the sound effects are added is written using a pen or a similar writing instrument.

In the example illustrated in FIG. 13, the information written on the whiteboard WB includes text information D1, text information D2, and connecting line information L1, L2, L3, and L4. The text information D1 corresponds to an input terminal, and the text information D2 corresponds to an output terminal. The connecting line information L1 is information that connects the text information D1 and the effector card CR2 to each other.

The connecting line information L2 is information that connects the effector card CR2 and the effector card CR1 to each other. The connecting line information L3 is information that connects the effector card CR1 and the effector card CR3 to each other. The connecting line information L4 is information that connects the effector card CR3 and the text information D2 to each other. The text information D1 and D2 each may be a medium such as a card and a sticker. The connecting line information L1, L2, L3, and L4 each may be a medium such as a wire and a string or may take any other form insofar as each information functions as relation information that relates the plurality of effector cards to each other.

For example, when a particular instruction (such as an instruction for determining initial state) is input, the information extractor 101 extracts information written on the whiteboard WB in the imaging range PA. Specifically, the information extractor 101 extracts the text information D1, the text information D2, the connecting line information L1, L2, L3, and L4, and the positions of the effector cards CR1, CR2, and CR3 (feature information of each of the effector cards CR1, CR2, and CR3). Then, the information extractor 101 transmits the extracted information to the parameter setter 111. The parameter setter 111 identifies the order in which the effector cards are arranged on the path from D1 (input terminal) to D2 (output terminal). In the example illustrated in FIG. 13, the parameter setter 111 identifies the order in which the effector cards are arranged on the path as CR2, CR1, and CR3.

As a result, in the display area DA, the effector images are aligned in the order of CG2, CG1, and CG3 from the left. As illustrated in FIG. 13, an order-illustrating arrow AR may be displayed. The order of the setting effectors, which add sound effects to sound signals, is SE2, SE1, and SE3. This order corresponds to the order in which the effector images are arranged.

To adjust the level setting value, an effector card is moved upward or downward, as described in the above embodiment. For example, when the effector card CR1 is moved, the effector card CR1 is moved away from the connecting line information L2 or L3. In this case as well, the identified arrangement order is maintained until the above-described particular instruction is input again.

Thus, by using relation information such as connecting line information, the user is able to intuitively set the order in which the sound effects are added to the sound signal (the order in which the setting effectors are arranged).

The configuration in which the signal output apparatus 1 performs signal processing on a sound signal supplied from an external device is not intended in a limiting sense. In the following embodiment, a signal output apparatus 1A generates a sound signal based on a sound production instruction from an external device, adds sound effects to the generated sound signal, and outputs the resulting sound signal.

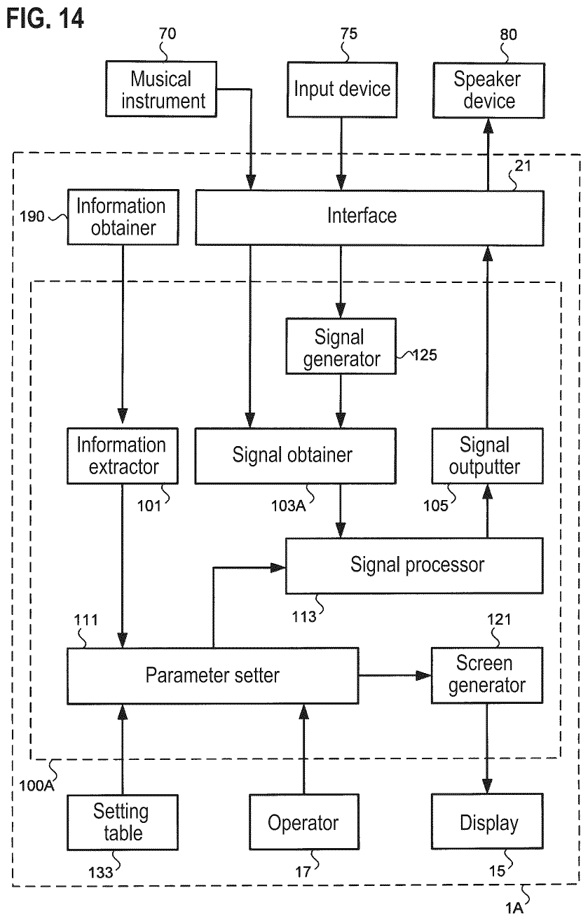

FIG. 14 is a schematic illustration of a functional configuration of a signal output apparatus according to this embodiment. An input device 75 is connected to the signal output apparatus 1A via the interface 21. An example of the input device 75 is a keyboard device with a plurality of keys. The keyboard device outputs a sound production instruction signal based on an operation of the keys. The sound production instruction signal is supplied to the signal output apparatus 1A via the interface 21. The input device 75 and the signal output apparatus 1A may be configured integrally. This integral configuration can be regarded as an electronic keyboard instrument including the input device 75 and the signal output apparatus 1A.

A signal processing function 100A of the signal output apparatus 1A includes a signal obtainer 103A and a signal generator 125. The sound production instruction signal output from the input device 75 is supplied to the signal generator 125.

Based on the sound production instruction signal, the signal generator 125 generates a sound signal including a waveform of a preset tone. The signal obtainer 103A obtains the sound signal generated by the signal generator 125 and supplies the sound signal to the signal processor 113. The signal obtainer 103A obtains a sound signal from the musical instrument 70 and supplies the sound signal to the signal processor 113, similarly to the signal obtainer 103 according to the above-described embodiment.

The signal obtainer 103A may synthesize the sound signal generated by the signal generator 125 with the sound signal obtained from the musical instrument 70, and supply the synthesized sound signal to the signal processor 113. Alternatively, the signal obtainer 103A may select one of the sound signals and supply the selected sound signal to the signal processor 113. It may be the user that presets which of the sound signals is to be selected. In this case, the signal obtainer 103A may supply the unselected sound signal to the signal outputter 105. Then, the signal outputter 105 may synthesize the sound signal supplied from the signal processor 113 with the sound signal supplied from the signal obtainer 103A, and output the synthesized sound signal to the speaker device 80.

The signal processor 113 adds sound effects to the sound signal generated by the signal generator 125. Therefore, a sound source section that generates a sound signal corresponding to the tone that has been set can be regarded as being implemented by both the function of the signal generator 125 and the function of the signal processor 113.

In the above-described embodiment, the setting of a sound effect is changed by moving a corresponding one of the effector cards arranged in the imaging range PA. Thus, the effector cards remain within the imaging range PA, even though the effector cards are movable within the imaging range PA. Another possible example is that the setting of a sound effect may be changeable even if the corresponding effector card is removed from the imaging range PA after the initial state of the effector card has been determined, that is, after the signal output apparatus 1 has identified information regarding the effector card.

In the above-described embodiment, when the initial states of the effector cards CR1, CR2, and CR3 are determined, a setting screen is displayed as illustrated in FIG. 5. In the following embodiment, this setting screen remains unchanged even after the effector cards CR1, CR2, and CR3 are removed from the imaging range PA. In this configuration, it is not necessary for the information extractor 101 to obtain extraction positions after the initial states have been determined. It is to be noted, however, that the finger positions are detected similarly to the above-described embodiment. In a case that the finger detection positions exist in the area where an effector card existed, the controller 11 displays in the display area DA a setting change screen on which to adjust the parameter setting value.

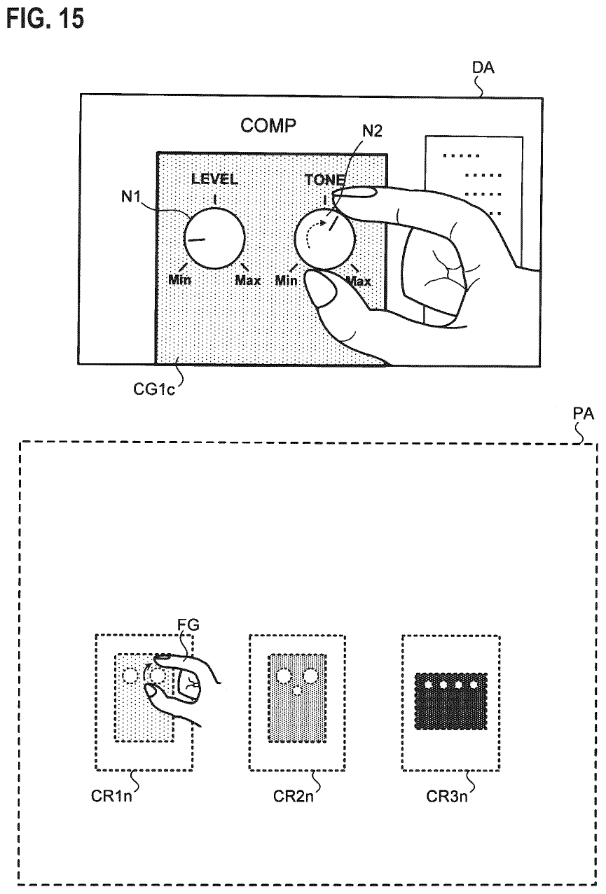

FIG. 15 is a schematic illustration of the setting change screen according to this embodiment. In FIG. 15, areas CR1n, CR2n, and CR3n in the imaging range PA respectively indicate the positions of the effector cards CR1, CR2, and CR3 at the time when the initial states of the effector cards CR1, CR2, and CR3 were determined. As illustrated in FIG. 15, the effector cards CR1, CR2, and CR3 are removed after the initial states of the effector cards CR1, CR2, and CR3 are determined, and then the user's fingers FG move into the area CR1n. The user's fingers FG are instruction object examples for inputting an instruction into the signal output apparatus 1.

Upon detection of the existence of finger detection positions in the area CR1n, the controller 11 displays a setting change screen in the display area DA. In the setting change screen, an enlarged effector image CG1c is displayed. The enlarged effector image CG1c corresponds to the effector card CR1, which existed in the area CR1n. The enlarged effector image CG1c is an image similar to the enlarged effector image CG1a illustrated in FIG. 7. Also in the setting change screen, a finger image FS is displayed over the enlarged effector image CG1c.

The finger image FS is an image corresponding to the fingers FG extracted from the captured image and an instruction image example. The position at which the finger image FS is displayed is determined based on the relationship with the area CR1n (area where the effector card CR1 existed at the time when the initial state was determined) in the imaging range PA. The finger image FS is superimposed over the enlarged effector image CG1c to realize an “MR (Mixed Reality)”.

For example, it will be assumed that the user moves the fingers FG while looking at the display area DA to cause the finger image FS to pinch and turn the knob image N2 as illustrated in FIG. 15. The controller 11 detects that the finger image FS is pinching the knob image N2 based on the positional relationship between the finger detection positions and the knob image N2. Further, the controller 11 detects that the finger image FS is turning the knob image N2. Then, the controller 11 controls the knob image N2 to turn as illustrated in FIG. 15. The controller 11 adjusts the parameter setting value based on the degree of rotation of the knob image N2 (adjusts the tone setting value in this example).

Thus, in this embodiment, an MR can be realized after the effector cards have been removed. Specifically, the finger image FS, which has been obtained by capturing the actual fingers FG, is superimposed over the enlarged effector image displayed in the display area DA to realize an MR. That is, the user operates the enlarged effector image CG1c, which is displayed in the setting change screen, using the fingers FG via the finger image FS. In this manner, the user is able to adjust the parameter setting value.

In the above-described embodiment, the information obtainer 190 corresponds to the imager 19. Therefore, the target from which the information extractor 101 extracts the feature information is the captured image corresponding to the imaging range PA. The target, however, will not be limited to the captured image. For example, in a case that each effector card includes an IC chip storing feature information, the information extractor 101 may extract the feature information from the IC chip. In the following embodiment, RFID (Radio Frequency IDentification) technology is used.

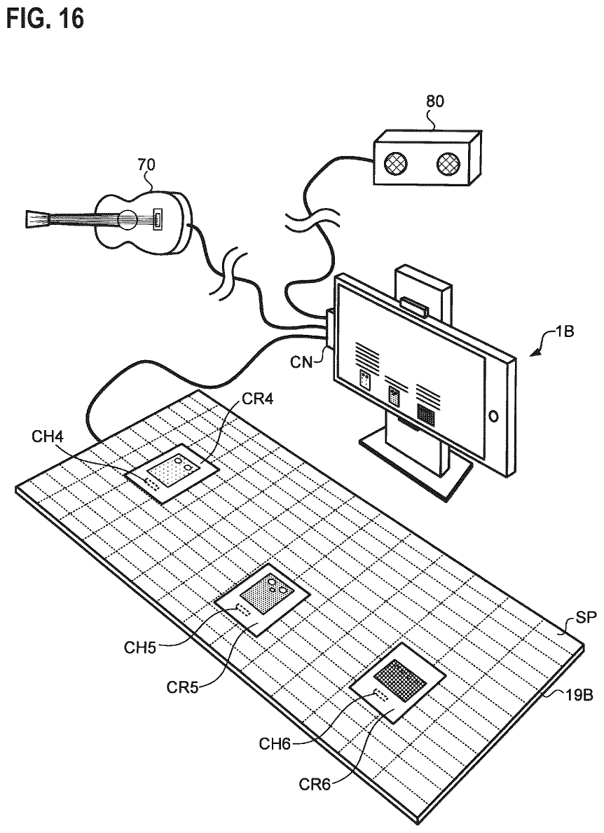

FIG. 16 is a schematic illustration of an example application of a signal output apparatus 1B according to this embodiment. In this example, a wireless communication panel 19B is connected to the signal output apparatus 1B. While the wireless communication panel 19B corresponds to the above-described information obtainer 190, the wireless communication panel 19B is connected to the information extractor 101 via the interface 21. The wireless communication panel 19B includes a plurality of meshed detection areas SP. Each detection area SP is equipped with coils or similar devices that retrieve information from an IC chip in the each detection area SP using RFID technology. The wireless communication panel 19B transmits a detection signal including the retrieved information to the signal output apparatus 1B.

As illustrated in FIG. 16, effector cards CR4, CR5, and CR6 are respectively equipped with IC chips CH4, CH5, and CH6. The IC chips CH4, CH5, and CH6 respectively make the effector cards CR4, CR5, and CR6 communicable by RFID technology. In the configuration in which the effector cards CR4, CR5, and CR6 are provided on the wireless communication panel 19B, the information obtainer 190 (the wireless communication panel 19B) receives feature information from the detection area SP corresponding to the position of an effector card (more precisely, the position of an IC chip). Then, the wireless communication panel 19B transmits, to the signal output apparatus 1B, a detection signal including the feature information and information indicating the position of the detection area SP.

In this embodiment, the information extractor 101 extracts the feature information from the detection signal transmitted from the wireless communication panel 19B. The information extractor 101 also identifies the position at which the feature information was extracted. In this manner, the signal output apparatus 1B identifies the sound effect type corresponding to each effector card and the position of the each effector card. Thus, the target from which the information extractor 101 extracts feature information will not be limited to the captured image obtained by the imager 19; the target may be a detection signal including information obtained by wireless communication or other means.

In this embodiment, the detailed setting processing may not necessarily be performed, or may be performed by the method described in the above-described embodiment, that is, by detecting the finger position from the captured image obtained by the imager 19. The wireless communication panel 19B may include a proximity sensor to detect the position and movement of fingers. In this configuration, the finger position may be detected based on a detection result obtained by the proximity sensor.

In the following embodiment, a signal output apparatus 1C will be described. After a parameter setting value is adjusted, the signal output apparatus 1C records the adjusted setting value of in the effector card.

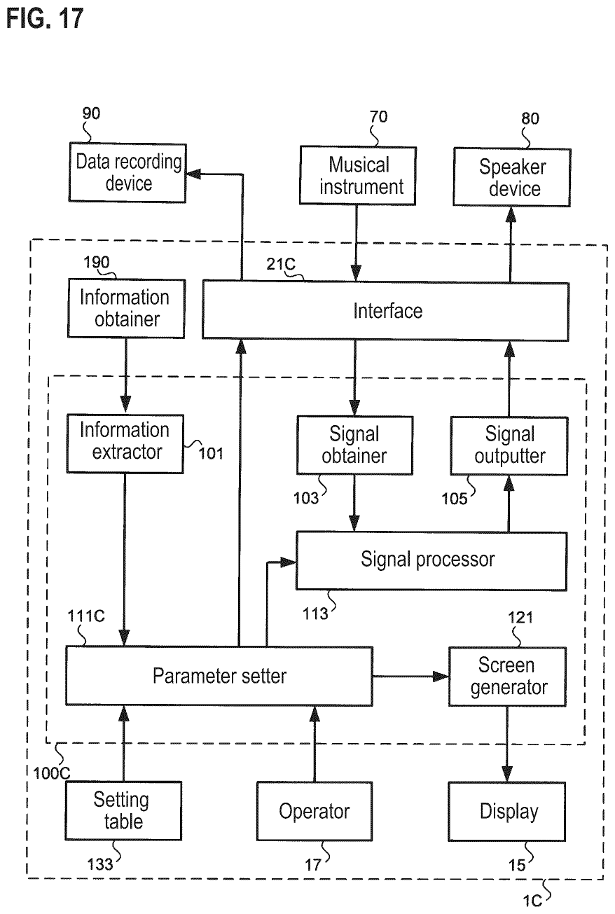

FIG. 17 is a schematic illustration of a functional configuration of the signal output apparatus 1C according to this embodiment. The signal output apparatus 1C according to this embodiment outputs a parameter setting value to a data recording device 90. The data recording device 90 is connected to the signal output apparatus 1C via the interface 21. At an instruction from the operator 17, a parameter setter 111C of the signal processing function 100C outputs, to the data recording device 90 via the interface 21, a parameter setting value for each sound effect type (for each setting effector).

The data recording device 90 is connected with a storage medium such as a memory card to record data in the storage medium. The data recording device 90 records, in the storage medium, a parameter setting value output from, for example, the signal output apparatus 1C. The parameter setting value recorded in the storage medium may be retrieved by an other signal output apparatus and used as a parameter setting value in the other signal output apparatus, or may be retrieved by an actual effector and used as a parameter setting value in the effector.

This embodiment may be applied to the signal output apparatus 1B according to the above-described embodiment. In this case, each of the effector cards CR4, CR5, and CR6 may include a storage medium to record the parameter setting value. The storage medium may be included in each of the IC chips CH4, CH5, and CH6. The wireless communication panel 19B may include the data recording device 90. In this case, the data recording device 90 may record the parameter setting value in each storage medium using the coils or similar devices in each detection area SP. This configuration ensures that the parameter setting value corresponding to each effector card can be recorded in the storage medium included in the each effector card. For example, the parameter setting value related to the effector card CR4 is recorded in the storage medium included in the effector card CR4. In this case, the parameter setting value can be recorded in the storage medium in a state in which the effector card CR4 is provided on the wireless communication panel 19B.

The signal output apparatus 1 according to one of the above-described embodiments and the speaker device 80 may not necessarily be housed in different enclosures but may be integral to each other.

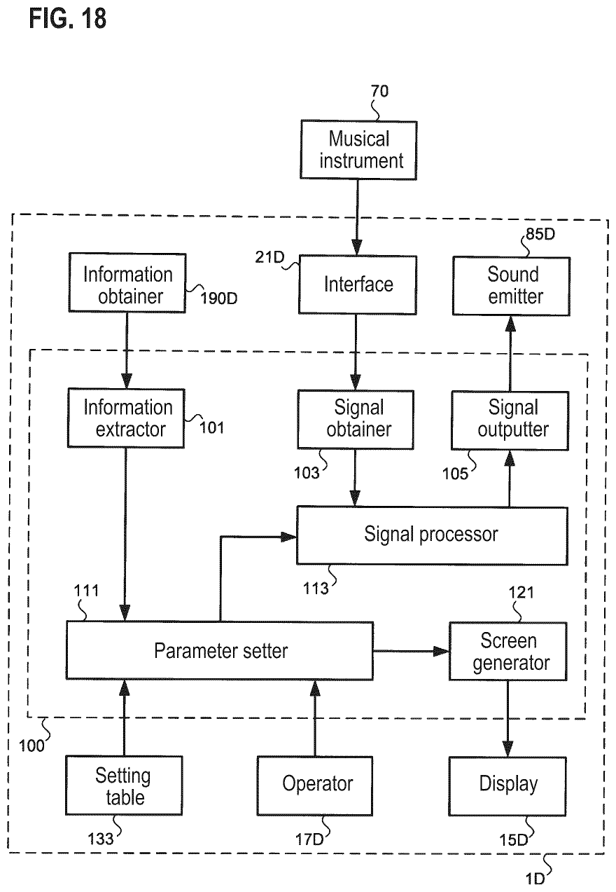

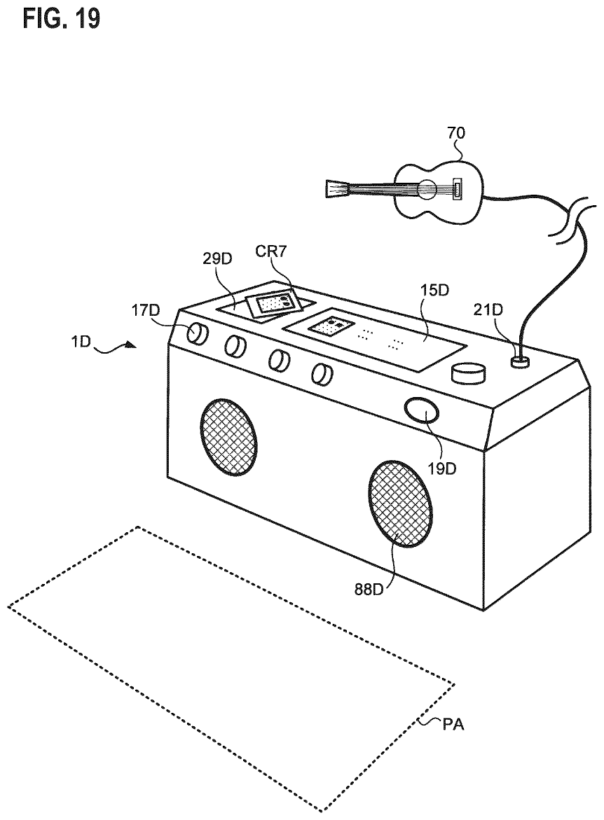

FIG. 18 is a schematic illustration of an exterior configuration of a signal output apparatus 1D according to this embodiment. FIG. 19 is a schematic illustration of a functional configuration of the signal output apparatus 1D according to this embodiment. The signal output apparatus 1D includes a sound emitter 85D. The sound emitter 85D includes an amplifier and a speaker unit 88D. The amplifier amplifies a sound signal that has been subjected to signal processing. The speaker unit 88D converts the amplified sound signal into an air vibration and outputs the air vibration. Thus, the signal output apparatus 1D can be regarded as an amplifier-equipped speaker apparatus.

The signal output apparatus 1D may include at least one of the imager 19D and a wireless communicator 29D, which constitute the information obtainer 190D. In this example, the signal output apparatus 1D includes both the imager 19D and the wireless communicator 29D. In this example, the imager 19D has its imaging range PA located in the direction in which the speaker unit 88D outputs a sound signal (plane direction before the signal output apparatus 1D). The imaging range PA may be set in other than the plane direction before the signal output apparatus 1D.

The wireless communicator 29D has a function to receive feature information from an effector card, as described in the wireless communication panel 19B according to one of the above-described embodiments. The wireless communicator 29D also has a function to obtain a parameter setting value from a storage medium that records the parameter setting value, as described in one of the above-described embodiments. In the example illustrated in FIG. 18, the wireless communicator 29D has a card installment area on the upper surface of the signal output apparatus 1D. In the card installment area, an effector card CR7 is provided. The wireless communicator 29D obtains various kinds of information from the effector card CR7. In this example, a display 15D and an interface 21D are provided on the upper surface of the signal output apparatus 1D. The display 15D includes the display area DA. The interface 21D is connectable with the musical instrument 70.

An operator 17D is provided on a surface at the front surface of the signal output apparatus 1D or on the front surface of the signal output apparatus 1D. There may be a case that sound effects are set by obtaining feature information from the effector cards via the wireless communicator 29D. In this case, the parameter setting values may be adjusted by operating the operator 17D by the user.

The signal output apparatus 1 may be connected to an external device such as a server via a network so that some of the functions of the signal output apparatus 1 are implemented by the server. That is, the functions of the signal output apparatus 1 may be implemented by a plurality of cooperating devices. In a case of the signal output apparatus 1C, the data recorded in the storage medium may be transmitted to the server, instead of to the data recording device 90, so that the data is recorded in a storage medium connected to the server. In the following embodiment, a function example implemented by the connection to an external device such as a server will be described.

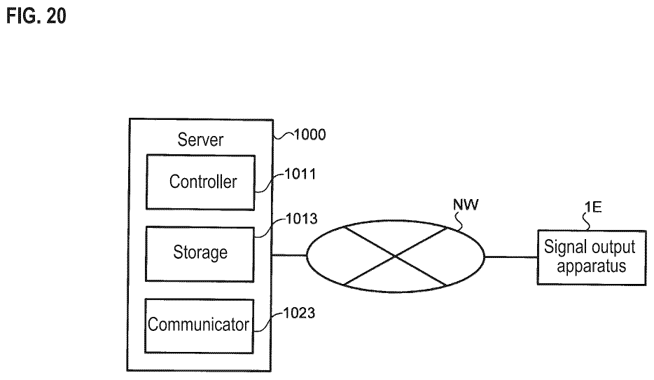

FIG. 20 is a schematic illustration of an example application of a signal output apparatus 1E according to this embodiment. The signal output apparatus 1E according to this embodiment communicates, at a communicator 1023, with a server 1000 via a network NW. The server 1000 includes a controller 1011, a storage 1013, and a communicator 1023. The controller 1011 has a hardware configuration corresponding to the controller 11. The communicator 1023 has a hardware configuration corresponding to the communicator 23.

The storage 1013 stores programs for implementing predetermined functions in the server 1000, a table to manage information such as a time management table, and a database. A program is executed by CPU of the controller 1011 to implement a function to perform, for example, a time management method described below.

The signal output apparatus 1E asks the server 1000 if the user has authorization to use an effector card. Based on the authorization, the signal output apparatus 1E sets a sound effect corresponding to the effector card. In this case, the signal output apparatus 1E requests in advance user information such as a user ID from the user, relates the user ID to identification information (for example, feature information) of the effector card, and transmit the resulting information to the server 1000. The server 1000 refers to the database to identify the authorization to use the effector card from the user ID. Then, the server 1000 transmits the authorization to the signal output apparatus 1E. The controller 11 of the signal output apparatus 1E sets the sound effect based on the authorization to use the effector card.

The authorization to use the effector card includes, for example, usage permission, usage prohibition, function restriction, or function alteration. In a case that the authorization to use the effector card is usage permission, the signal output apparatus 1E controls to enable the user to change all of the setting of the target sound effect. In a case that the authorization to use the effector card is usage prohibition, the signal output apparatus 1E controls the target sound effect to be unavailable. In a case that the authorization to use the effector card is function restriction, the signal output apparatus 1E controls to enable the user to change part of the setting of the target sound effect. In a case that the authorization to use the effector card is function alteration, the signal output apparatus 1E controls to change the sound quality of the signal processing associated with the target sound effect (for example, degrade the sound quality).

The authorization to use the effector card may be set in advance for each user, or may be changed based on the usage time of the effector card. For example, for one user, the authorization to use the effector card may be changed from usage permission to usage prohibition when the usage time of the sound effect related to the effector card CR1 reaches a predetermined upper limit. In this case, the signal output apparatus 1E relates usage information identification information related to the effector card. The usage information includes the usage time of the setting effector corresponding to the effector card (the time for which the signal processing is performed to add the sound effect). Then, the signal output apparatus 1E transmits the resulting information to the server 1000. The signal output apparatus 1E periodically transmits the usage information to the server 1000 during the usage of the setting effector. The usage information may be information indicating that the setting effector is in use, instead of indicating the usage time of the setting effector. In this case, the server 1000 calculates the usage time. The server 1000 relates the usage time to the identification information, and registers the resulting information in the time management table. The server 1000 also refers to the time management table and transmits the authorization to use the effector card to the signal output apparatus 1E.

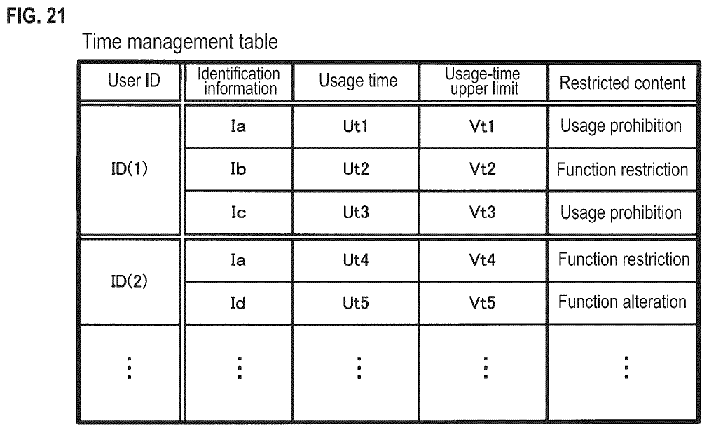

FIG. 21 is a schematic illustration of the time management table according to this embodiment. In the example illustrated in FIG. 21, the time management table specifies, for each user ID, a relationship between identification information related to the effector card, usage time, usage-time upper limit, and restricted content. For example, user ID(1) is related to feature information Ia, Ib, and Ic as identification information. Also in the user ID(1), the feature information Ia is related to the user's usage time Ut1, usage-time upper limit Vt1, and restricted content “Usage prohibition”. These values may vary depending on the user. In the example illustrated in FIG. 21, for user ID(2), the feature information Ia is related to usage-time upper limit and restricted content respectively different from the usage-time upper limit and restricted content related to the user ID(1).

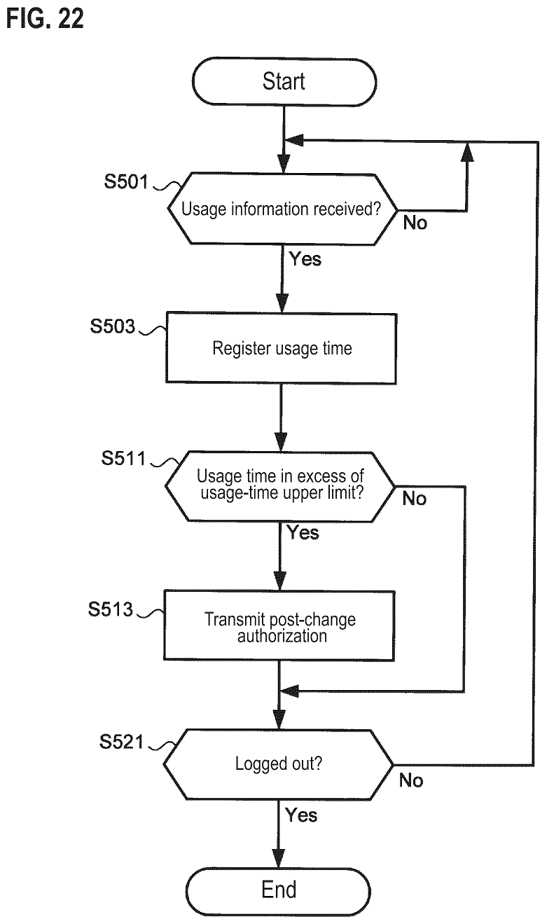

FIG. 22 is a schematic illustration of the time management method according to this embodiment. The time management method starts upon receipt of log-in processing performed by a user ID in the signal output apparatus 1E. The server 1000 waits until receipt of the usage information from the signal output apparatus 1E (No at step S501). Upon receipt of the usage information (Yes at step S501), the server 1000 registers, in the time management table, the usage time corresponding to the identification information for each user ID based on the usage information (step S503).

In a case that the usage time is in excess of the usage-time upper limit (Yes at step S511), the server 1000 changes the authorization to use the effector card corresponding to the target identification information to the restricted content specified in the time management table, and transmits the post-change authorization to the signal output apparatus 1E (step S513). Then, or in a case that the usage time is not in excess of the usage-time upper limit (No at step S511), if the target user ID is not logged out (No at step S521), the server 1000 waits again until receipt of the usage information from the signal output apparatus 1E (No at step S501). If the target user ID is logged out (Yes at step S521), the server 1000 ends the time management method.

Based on the authorization to use the effector card transmitted from the server 1000, the signal output apparatus 1E sets the sound effect corresponding to the effector card. This control ensures that the usage time of the effector card can be made variable, allowing for the implementation of a trial version of the effector card. The usage of function alteration for the authorization to use the effector card ensures that the more the effector card is used, the more the sound effect is changed, simulating the aging process of an actual device. The effector card can be offered to the user as if the effector card has aged over time from the initial state, simulating the qualities of a vintage device. In this case, the feature information may include the time passed.

The authorization to use the effector card may be variable depending on information regarding a usage history other than the usage time; for example, the number usage of times. Thus, the controller 11 performs signal processing on a sound signal such that the setting value of a parameter for a sound effect is adjusted based on a usage history.

The feature information included in the effector card may be made exclusive, so that this feature information is not included in other effector cards. That is, even if there are two effector cards corresponding to the same identical sound effect type, one effector card may include unique individual information to distinguish from the other effector card. This configuration ensures that each individual effector card can be distinguished from the other effector cards. As a result, the authorization to use each effector card can be set independently of the user ID.

The present disclosure will not be limited to the above-described embodiments and are open to various other modifications. For example, the above-described embodiments have been described in detail to facilitate understanding of the present disclosure and are not necessarily limited to including all the components described. A configuration from one embodiment can be substituted with a configuration from another embodiment, or a configuration from one embodiment can be combined with a configuration from another embodiment. Each configuration described in the above embodiments can be partially or entirely subject to addition, deletion, or replacement with another configuration. Possible modifications will be described below. While the following modifications illustrate changes to one of the above-described embodiments, the modifications are also applicable to other embodiments.

(1) In one of the above-described embodiments, the setting screen is displayed in the display area DA. Another possible example is that the setting screen is displayed in the display area DA. The effector images may not necessarily be displayed in the display area DA. The display 15 may not necessarily be included in the signal output apparatus 1. In this case, the screen generator 121 may not necessarily be included in the signal processing function 100.

(2) In one of the above-described embodiments, a level setting value is adjusted by moving an effector card in the imaging range PA. Another possible example is that a parameter other than a level setting value is adjusted. In this case, the target parameter to be adjusted may be determined in advance for each effector card.

(3) The information obtainer 190 may include a retrieving device that retrieves feature information from a storage medium connected to the information obtainer 190 via a wire.

(4) The storage medium storing the feature information will not be limited to the above-described effector card; the storage medium may be a three-dimensional structure such as a figure or may be at least a part of a musical instrument. Examples of at least a part of a musical instrument include operable structures such as knobs and sliders. Other examples include areas displaying patterns such as logo marks.

(5) There may be a case that the user draws or makes scratches on the effect card. This case is equivalent to adding or modifying the feature information included in the effect card. In this case, the sound effect type or the parameter setting value may be adjusted by the added feature information.

In the above-described embodiments, the information obtainer may include an imager configured to generate an image of a predetermined imaging range. When the identification information is obtained, the at least one processor may be caused to extract the identification information corresponding to the medium from the image generated by the imager.

The program may further cause the at least one processor to display an identification image on a display based on the identification information.

The program may further cause the at least one processor to obtain the sound signal from an external device. The at least one processor may be caused to subject the sound signal obtained from the external device to the signal processing.

The identification information may include information for identifying a type of a parameter used in the signal processing. The signal processing performed based on the identification information may include processing using a parameter identified by the identification information.

The program may further cause the at least one processor to measure a change in a position of the medium and, based on the change in the position of the medium, change a setting value of the parameter used in the signal processing.

The program may further cause the at least one processor to measure a change in an orientation of the medium and change the setting value of the parameter based on the change in the orientation of the medium.

The program may further cause the at least one processor to measure an operation state indicating how a user is operating the medium and, based on the operation state, change a setting value of the parameter used in the signal processing.

The program may further cause the at least one processor to record, in the medium, a setting value of the parameter used in the signal processing.

The signal processing may include processing performed based on a setting value of the parameter retrieved from the medium.

The program may further cause the at least one processor to obtain the sound signal from a signal generator that generates the sound signal based on a sound production instruction signal. The at least one processor may be caused to subject the sound signal obtained from the signal generator to the signal processing.

In a case that the at least one processor is caused to obtain first identification information from a first medium and obtain second identification information from a second medium, the signal processing may include processing performed based on the first identification information, the second identification information, and a positional relationship between the first medium and the second medium.

In a case that the at least one processor is caused to obtain first identification information from a first medium, obtain second identification information from a second medium, and obtain relation information that relates the first medium and the second medium to each other, the signal processing may include processing performed based on the first identification information, the second identification information, and the relation information.

The signal processing may include processing performed based on a usage history of the identification information.

The information obtainer may include an imager configured to generate an image of a predetermined imaging range. The identification information may include information for identifying a type of a parameter used in the signal processing. The signal processing performed based on the identification information may include processing using a parameter identified by the identification information. The program may further cause the at least one processor to, based on the identification information, display an identification image corresponding to the medium on a display. The program may further cause the at least one processor to extract a predetermined instruction object from the image generated by the imager. The program may further cause the at least one processor to display an instruction image of the predetermined instruction object on the display. The program may further cause the at least one processor to, based on a positional relationship between the identification image and the instruction image, change a setting value of a parameter used in the signal processing.

The signal output apparatus may further include a sound emitter configured to amplify the sound signal output from the signal outputter to convert the sound signal into an air vibration.

The signal output apparatus may further include a signal obtainer configured to obtain the sound signal from an external device. The signal processor may be configured to subject the sound signal obtained by the signal obtainer to the signal processing based on the identification information.

The signal output apparatus may further include a signal generator configured to generate the sound signal based on a sound production instruction signal. The signal processor may be configured to subject the sound signal generated by the signal generator to the signal processing.

The information obtainer may include an imager configured to generate an image of a predetermined imaging range. The identification information may include information for identifying a type of a parameter used in the signal processing. The signal processing performed based on the identification information may include processing using a parameter identified by the identification information. The signal output apparatus may include a screen generator and a parameter setter. The screen generator is configured to, based on the identification information, display an identification image corresponding to the medium on a display. The screen generator is also configured to extract a predetermined instruction object from the image generated by the imager. The screen generator is also configured to display an instruction image of the predetermined instruction object on the display. The parameter setter is configured to, based on a positional relationship between the identification image and the instruction image, change a setting value of the parameter used in the signal processing.

The embodiments of the present disclosure improve the operability of parameter settings in devices that perform signal processing, such as for sound effects.

While an embodiment of the present disclosure and a modification of the embodiment have been described, the embodiment and the modification are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiment and the modification. Thus, these embodiments and modifications thereof are intended to be encompassed by the scope of the present disclosure. The scope of the present invention accordingly is to be defined as set forth in the appended claims.

What is claimed is:

1. A non-transitory computer-readable storage medium storing a program which, when executed by at least one processor, causes the at least one processor to:
obtain identification information regarding sound processing from a medium via an information obtainer;
subject a sound signal to the signal processing based on the identification information; and
output the sound signal that has been subjected to the signal processing.

2. The non-transitory computer-readable storage medium according to claim 1, wherein
the information obtainer includes an imager configured to generate an image of a predetermined imaging range, and
when the identification information is obtained, the at least one processor is caused to extract the identification information corresponding to the medium from the image generated by the imager.

3. The non-transitory computer-readable storage medium according to claim 1, wherein the program further causes the at least one processor to display an identification image on a display based on the identification information.

4. The non-transitory computer-readable storage medium according to claim 1, wherein
the program further causes the at least one processor to obtain the sound signal from an external device, and
the at least one processor is caused to subject the sound signal obtained from the external device to the signal processing.

5. The non-transitory computer-readable storage medium according to claim 1, wherein
the identification information includes information for identifying a type of a parameter used in the signal processing, and
the signal processing performed based on the identification information includes processing using the parameter identified by the identification information.

6. The non-transitory computer-readable storage medium according to claim 5, wherein the program further causes the at least one processor to:
measure a change in a position of the medium; and
based on the change in the position of the medium, change a setting value of the parameter used in the signal processing.

7. The non-transitory computer-readable storage medium according to claim 5, wherein the program further causes the at least one processor to:
measure a change in an orientation of the medium; and
change the setting value of the parameter based on the change in the orientation of the medium.

8. The non-transitory computer-readable storage medium according to claim 5, wherein the program further causes the at least one processor to:
measure an operation state indicating how a user is operating the medium; and
based on the operation state, change a setting value of the parameter used in the signal processing.

9. The non-transitory computer-readable storage medium according to claim 5, wherein the program further causes the at least one processor to record, in the medium, a setting value of the parameter used in the signal processing.

10. The non-transitory computer-readable storage medium according to claim 9, wherein the signal processing includes processing performed based on the setting value of the parameter retrieved from the medium.

11. The non-transitory computer-readable storage medium according to claim 1, wherein
the program further causes the at least one processor to obtain the sound signal from a signal generator that generates the sound signal based on a sound production instruction signal, and
the at least one processor is caused to subject the sound signal obtained from the signal generator to the signal processing.

12. The non-transitory computer-readable storage medium according to claim 1, wherein in a case that the at least one processor is caused to obtain first identification information from a first medium and obtain second identification information from a second medium, the signal processing includes processing performed based on the first identification information, the second identification information, and a positional relationship between the first medium and the second medium.

13. The non-transitory computer-readable storage medium according to claim 1, wherein in a case that the at least one processor is caused to obtain first identification information from a first medium, obtain second identification information from a second medium, and obtain relation information that relates the first medium and the second medium to each other, the signal processing includes processing performed based on the first identification information, the second identification information, and the relation information.

14. The non-transitory computer-readable storage medium according to claim 1, wherein the signal processing includes processing performed based on a usage history of the identification information.

15. The non-transitory computer-readable storage medium according to claim 1, wherein
the information obtainer includes an imager configured to generate an image of a predetermined imaging range,
the identification information includes information for identifying a type of a parameter used in the signal processing,
the signal processing performed based on the identification information includes processing using the parameter identified by the identification information, and
the program further causes the at least one processor to:
based on the identification information, display an identification image corresponding to the medium on a display;
extract a predetermined instruction object from the image generated by the imager;
display an instruction image of the predetermined instruction object on the display; and
based on a positional relationship between the identification image and the instruction image, change a setting value of the parameter used in the signal processing.

16. A signal output apparatus comprising:
an information obtainer configured to obtain identification information regarding sound processing from a medium;
a signal processor configured to subject a sound signal to the signal processing based on the identification information; and
a signal outputter configured to output the sound signal subjected to the signal processing.

17. The signal output apparatus according to claim 16, further comprising a sound emitter configured to amplify the sound signal output from the signal outputter to convert the sound signal into an air vibration.

18. The signal output apparatus according to claim 16, further comprising a signal obtainer configured to obtain the sound signal from an external device, wherein
the signal processor is configured to subject the sound signal obtained by the signal obtainer to the signal processing based on the identification information.

19. The signal output apparatus according to claim 16, further comprising a signal generator configured to generate the sound signal based on a sound production instruction signal, wherein
the signal processor is configured to subject the sound signal generated by the signal generator to the signal processing.

20. The signal output apparatus according to claim 16, wherein
the information obtainer includes an imager configured to generate an image of a predetermined imaging range,
the identification information includes information for identifying a type of a parameter used in the signal processing,
the signal processing performed based on the identification information includes processing using the parameter identified by the identification information, and
the signal output apparatus includes
a screen generator configured to:
based on the identification information, display an identification image corresponding to the medium on a display;
extract a predetermined instruction object from the image generated by the imager; and
display an instruction image of the predetermined instruction object on the display, and
a parameter setter configured to, based on a positional relationship between the identification image and the instruction image, change a setting value of the parameter used in the signal processing.
